(19) United States
(12) Patent Application Publication
(10) Pub. No.: US 2011/0231285 A1
(43) Pub. Date: Sep. 22, 2011

(54) RETAIL MOBILE POINT-OF-SALE (POS) SOFTWARE APPLICATION

(75) Inventors: Karl Englund, Rancho Cucamonga, CA (US); Dennis Carson, Rancho Cucamonga, CA (US); Arthur Matiossian, Rancho Cucamonga, CA (US)

(73) Assignee: APP MASTERS LLC

(21) Appl. No.: 13/048,802

(22) Filed: Mar. 15, 2011

Related U.S. Application Data
(60) Provisional application No. 61/314,502, filed on Mar. 16, 2010.

(51) Int. Cl. G06Q 30/00

(52) U.S. Cl. 705/26.41; 705/27.1

(57) ABSTRACT

A portable electronic device includes a memory and processor. The memory stores instructions, which are part of a retail mobile software purchase software application. The instructions, which when executed by the processor cause the portable electronic device to first transmit an item search request. The device receives item information including item description and item price and also receives an item selection to purchase the item. The retail mobile software creates an order including the selected item and may add other selected items to the order. The retail mobile software application displays payment options for the order and receives a payment option selection for the order including the selected item. The retail mobile software application receives payment confirmation for the order including the selected item and displays receipt options for the order including the selected item. The retail mobile software application generates an electronic receipt for the order.

### RELATED APPLICATIONS

This application claims priority under 35 U.S.C. §119(e) to U.S. Provisional Application Ser. No. 61/314,502 filed Mar. 16, 2010, entitled “Retail Software Application,” which is incorporated by reference.

### BACKGROUND OF THE INVENTION

In the past, retailers have had a hard time providing customer service to customers who still shop in physical stores. With online shopping available and easily accessible to most purchasers, retailers desire to make the shopping experience a pleasant and quick experience. During rush times (sales events, evening hours, weekends, holiday seasons, etc.), many purchasers visit the physical retail location.

Retail salespeople and managers have a difficult time assisting all of the customers because during these rush times, the cheek out lines become very long (requiring that the maximum number of cashiers be staffed) and the inventory stock in the store may become very disorganized. In addition, many customers are looking for sizes that may not be out on display or are looking for help in finding items that were displayed online or in advertisements. The purchasers want to spend as little time as possible waiting in line and do not want to wait in line to purchase items or to speak with a sales person.

In addition, during these rush times theft and inventory control are a problem because the retail store staff cannot monitor all purchasers who enter and exit the store. Because the central nature of checkout (i.e., purchasing items), more staff is concentrated in the checkout area of the store, which may leave the other areas of the retail location with very few staff to answer questions.

Accordingly, there is a need to develop an automated solution that allows retail store staff to be mobile (i.e., move to various locations within the retail store) and complete transactions (e.g., item search, price lookup, item purchase, etc.). Developing an automated solution including a portable electronic device and software would help alleviate the pain felt by both retailers and consumers in the form of lack of personalized customer service, long check out lines, theft & inventory control, product returns, and non-repeat customers.

### BRIEF DESCRIPTION OF THE DRAWINGS

FIGS. 1A-1D illustrate a computer-implemented process for purchasing a product in a retail embodiment utilizing a portable electronic device running a retail mobile software application according to an embodiment of the invention; and

FIG. 2 illustrates a portable electronic device having a scanner and including a retail purchase software application according to an embodiment of the invention;

### DETAILED DESCRIPTION OF THE INVENTION

The emphasis of PayMaster mobile POS software application is to relieve the retailer's pain and to greatly improve the guest's shopping experience by affording the retailer the ability to finally offer superior customer service and convenience at an affordable price, while reducing store overhead. In doing so, the highly customizable App Masters turnkey retail solution (the PayMaster software) is seamlessly and securely integrated and implemented with a client's current POS system. It provides a measurable degree of personal attention to customers, mobile check out with associates from anywhere on the selling floor, no waiting at check out, and improved guest's experience and satisfaction.

The system (the scanner and iPod touch coupled with our PayMaster retail POS software), uses a touch screen interface to access nearly every feature a salesperson would need to help a guest. It combines iPod Touch features with a magnetic stripe reader, advanced barcode scanner and software to speed plastic and cash transactions. This functionality and features may easily be transferred to other portable electronic devices, such as the iPad, or smartphones.

For credit card and instant credit transactions, guests or purchasers, write their signature on the device using finger entry and control. Any employee who has the portable electronic device can accept cash transactions. After entering all the products and totaling the cost, the employee presses an on-screen “Cash” button to electronically open one of any number of cash drawers installed around the store. Guests (or purchasers) will continue to have the option to receive a printed or e-mailed receipt, or both.

For product returns, the original purchase can be located by scanning the barcode of the purchase receipt. Without a receipt, the portable electronic device running the Paymaster Mobile POS software can search for the purchase by the guest's e-mail address, product serial number, or the credit/debit card number. The portable electronic device captures why the return is being made, and will then generate a credit to the guest's account, along with a printed or e-mailed receipt.

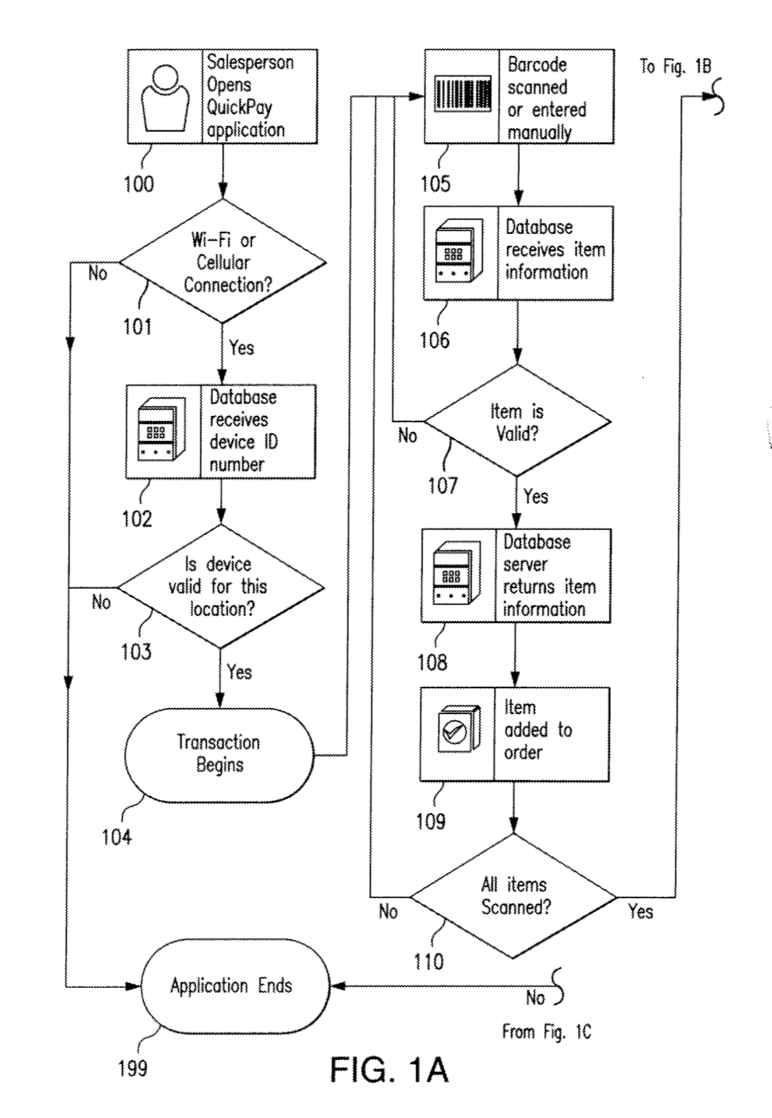

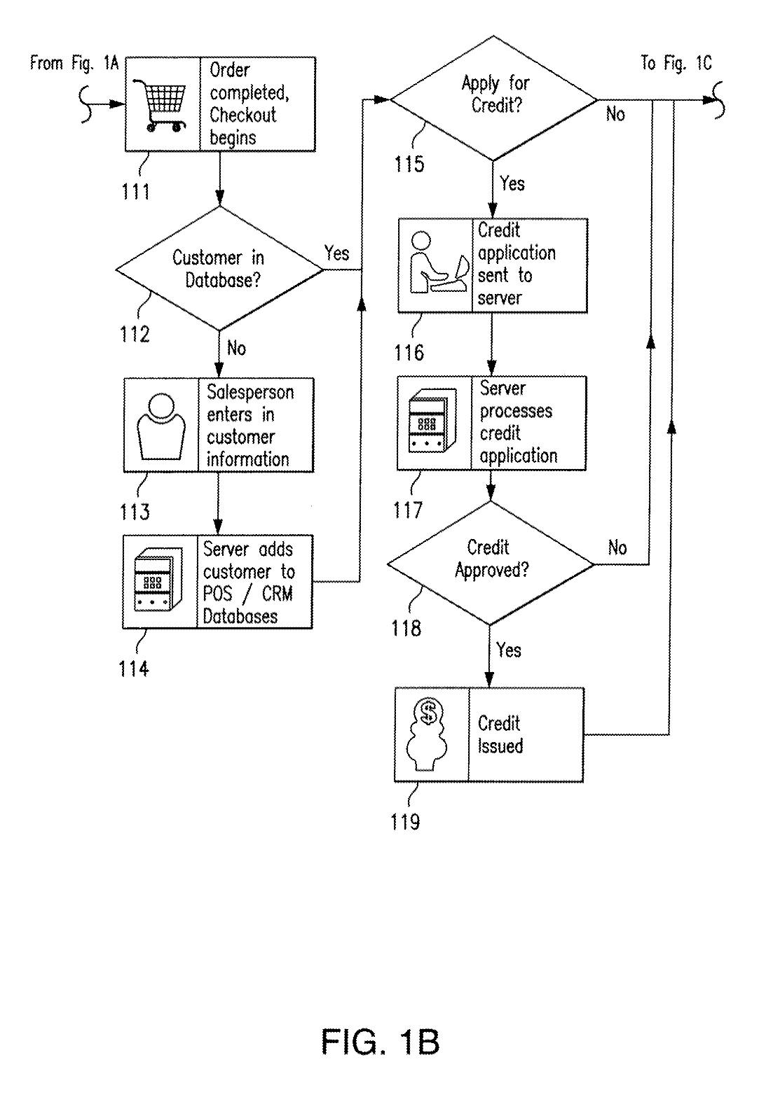

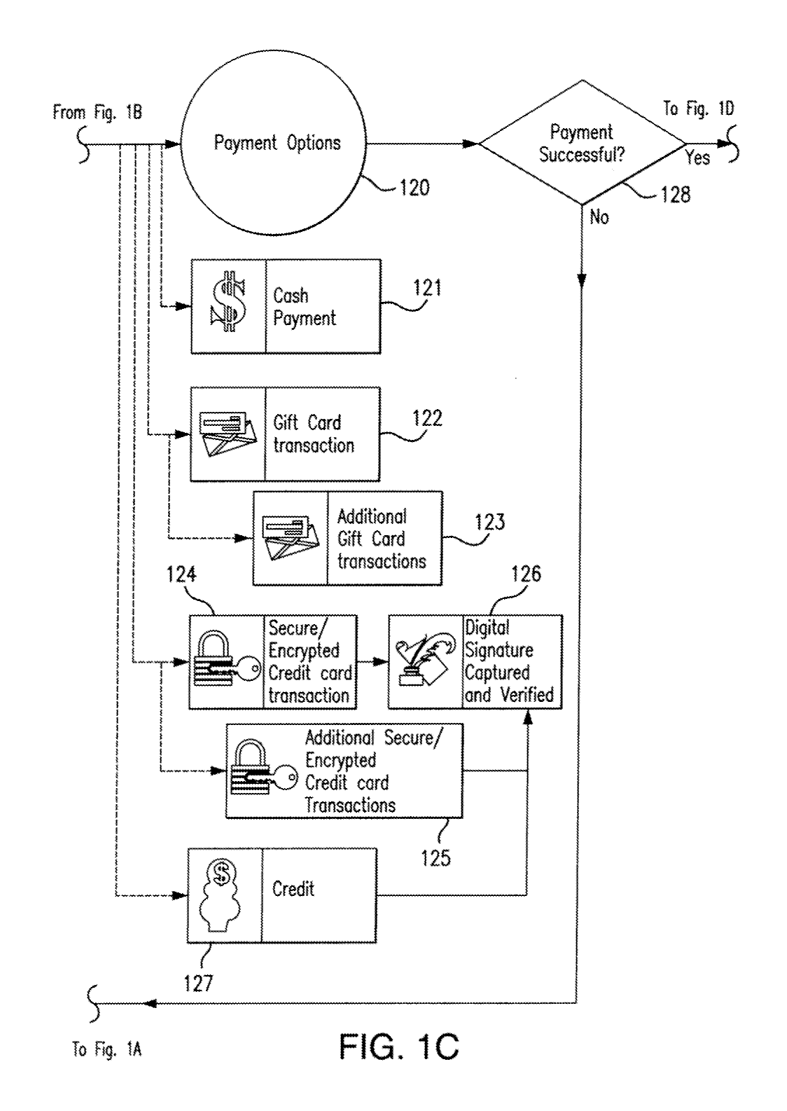

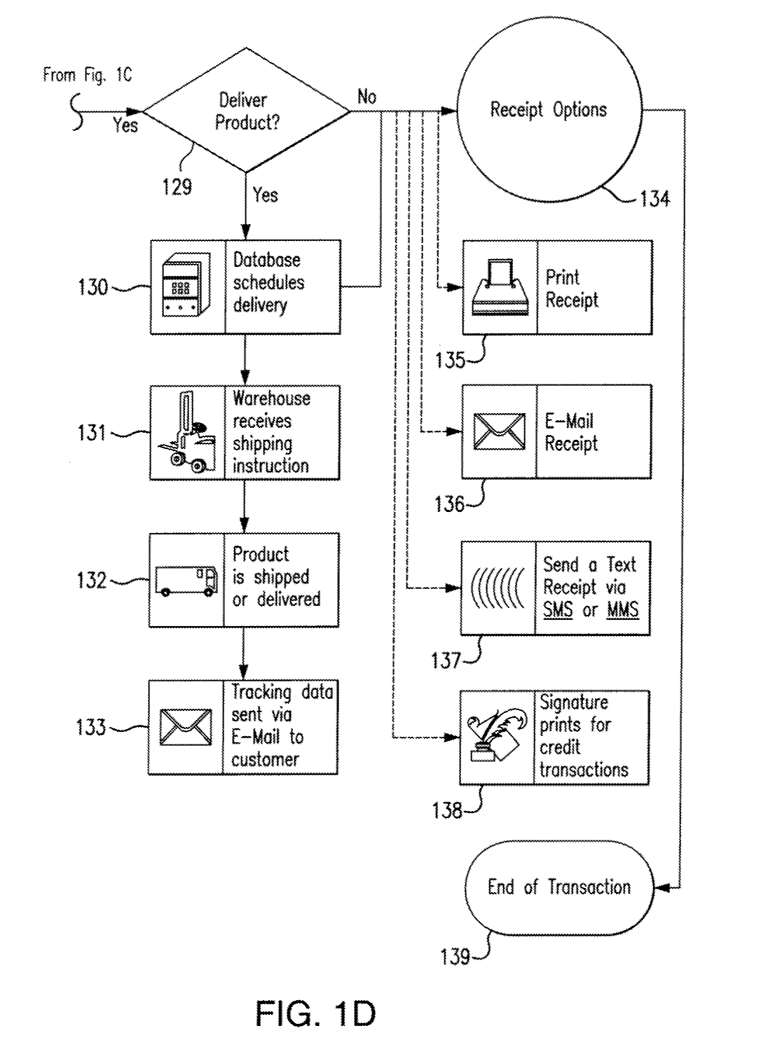

FIGS. 1A-1D illustrates a computer-implemented process for purchasing a product in a retail embodiment utilizing a portable electronic device running a retail mobile software application according to an embodiment of the invention. Illustratively, the retail mobile software application may be the PayMaster mobile POS software application.

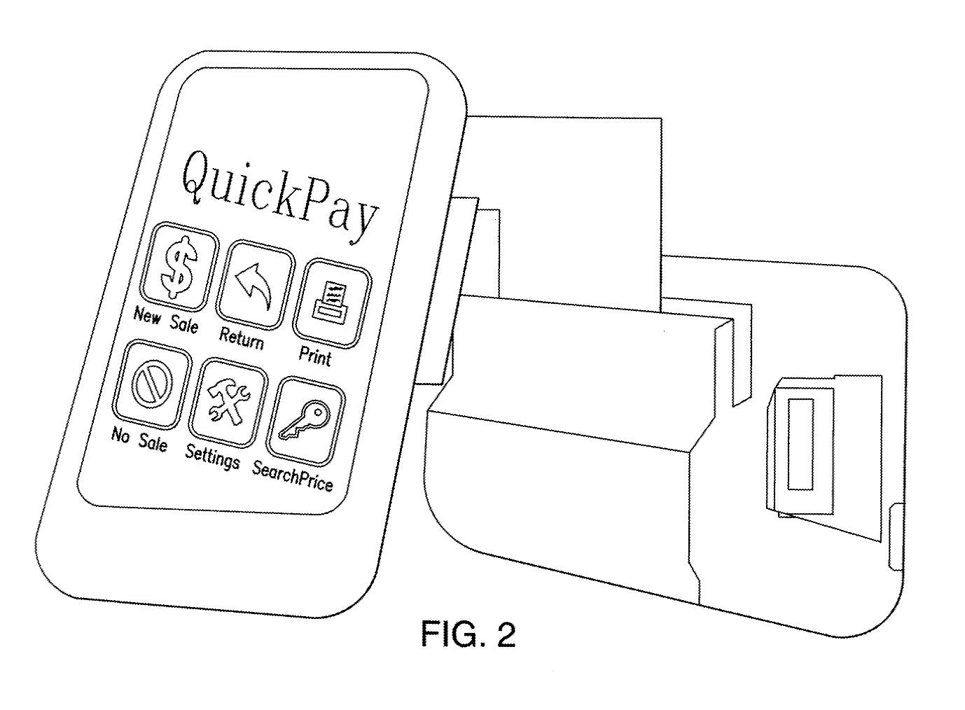

A salesperson in a retail environment has a portable electronic device including scanning capabilities and functionality. FIG. 2 illustrates a portable electronic device having a scanner and including a retail purchase software application according to an embodiment of the invention. The portable electronic device includes memory, a processor, non-volatile memory (such as a hard disk, a USB drive or a memory card), an input/output device that includes a barcode scanner, magnetic stripe reader, and a battery, a display, a payment-receiving device, and the retail mobile purchase software. The retail mobile software including instructions are stored in the non-volatile memory and are executed by the processor to cause the portable electronic device to perform the computer-implemented method. The retail mobile software application may be referred to hereinafter by a number of names, including Paymaster mobile software application, the retail mobile purchase software application and the Paymaster Mobile POS software application.

The portable electronic device communicates with a retail purchase server, which can be resident in the retail location, or that may physically reside in a remote location. In an embodiment of the invention, the retail location may have an existing server, with which the retail mobile purchase software application may communicate directly. If the retail location does not have a server, the retail mobile purchase software application may connect with the remote retail purchase server.

In an embodiment of the invention, if the retailer does not have an existing POS system, the retailer may install a retail purchase server. The retail purchase server may run software applications that perform a number of functions. The retail purchase server may include point-of sale (POS) server functionality and software, customer relationship management server (CRM) functionality and software, and an email server. The retail purchase server may also include a POS database for storing point-of-sale information and a CRM database for storing customer relationship management (CRM) information. Further, the retail purchase server may include a product database for storing item description and pricing information. The retail purchase server may include an inventory database to identify the inventory remaining of each item. In an embodiment of the invention, the retail purchase server may also be referred to as an existing customer software application or an existing customer server. Even if the term server is utilized, this still refers to the software applications running on the identified server. In the retail industry, there are many naming conventions for the retail purchase server, such as described above, and retailers may have many different names. Thus, the use of retail purchase server should not be limiting in that the retail purchase server may include functionality such as POS functionality, CRM functionality, inventory functionality, database functionality and email functionality.

A salesperson with a portable electronic device opens 100 retail mobile purchase software application. The retail mobile purchase software application communicates 101 with the retail purchase server via Wi-Fi if Wi-Fi is available. If Wi-Fi is not available in the location, the retail mobile purchase software may communicate with the retail purchase server via the cellular phone network. If neither Wi-Fi nor a cellular data connection is available, the retail mobile purchase software application may transmit 199 an error message to the display of the portable electronic device notifying the user of the communication failure.

Still referring to FIGS. 1A-1D, in an embodiment of the invention, the retail mobile purchase software on the portable electronic device transmits 102 its unique ID to the retail purchase server. The retail purchase server then verifies 103 that the portable electronic device (and/or the salesperson) is valid for this retail location and has an active status. If the device (and/or the salesperson) is not valid for this location, the retail mobile purchase software sends an error message, which is displayed on the portable electronic device and the retail mobile purchase software application ends 199.

The retail mobile purchase software application receives input identifying that a transaction is to begin 104. A salesperson utilizes the portable electronic device to scan 105 an item barcode and the retail mobile purchase software application receives the scanned item information. The retail mobile software application transmits 106 the scanned item information to the retail purchase server, which receives 106 the scanned item information. The retail purchase server determines 107 if the item is a valid item and if the item is not valid, the retail purchase server transmits a message to the retail mobile software application that the item is not valid, and the retail purchase server returns the user/salesperson to step 105. If the item is valid, the retail purchase server transmits 108 the product identification information, the retail mobile purchase software application then receives product identification information and adds 109 the item to a potential order. The potential order is created within the retail mobile purchase software application and stored in memory in the portable electronic device. The potential order is not a final order until all of the items have been added to the order and a checkout process has begun. The potential order is not transmitted to the retail purchase server because it is not in final form and may be cancelled, revised or suspended. If potential orders were transmitted to the retail purchase server, the retail purchase server would need to be cleaned of all potential orders at regular, intervals.

Alternatively, the retail mobile purchase software application running on the portable electronic device receives 105 product identification information input by the salesperson. The retail mobile purchase software application on the portable electronic device transmits the product identification information to a point of sale (POS) server. The POS server utilizes the product identification and validates 107 the product. If the product is valid, the server retrieves all applicable product information such as item description information, pricing, categories, taxable status, etc. 108. The item description information may include a description of the product, a price of the product, and a classification of the product.

Illustratively, if a potential order has not yet created, i.e., this is the first item, the retail mobile purchase software application creates 109 an order and the item is added to the newly-created potential order. If a potential order already exists in the retail mobile purchase server, then the item and the item description information are added 109 to the existing potential order.

The retail mobile purchase software on the portable electronic device continues to receive product identification information and continues to retrieve item description information and places this in an existing potential order until the retail mobile purchase software on the portable electronic device receives 111 an order completion command. After receiving the order completion command, the retail mobile purchase software may close out the potential order.

The retail mobile purchase application software may also include a customer relationship management module (or customer relationship management software application). The customer relationship management software application also includes, or interfaces with, a customer relationship management database. The customer relationship management database includes customer contact information, birth date information, purchase category information, purchase data information, demographic information, and address information. Retail stores utilize a customer relationship management database to track customers in order to target customers for specific offers and reward programs. In an embodiment of the invention, a customer record in the customer relationship management database may include a photo image of the customer.

After the retail mobile purchase software application in the portable electronic device receives the order completion command, the retail mobile purchase application software checks 112 to see if the customer who is Making the purchases is in the CRM database. The retail mobile purchase software application communicates with the CRM database in the retail purchase server to determine if the customer is within the database. If the customer is not in the CRM database, the retail mobile purchase software application in the portable electronic device receives 113 customer information input and this customer information input is transmitted to the retail purchase server and added 114 to the CRM and POS databases. In an embodiment of the invention, a salesperson or cashier may take a picture of the customer, store the image temporarily on the portable electronic device and transfer the customer image to the CRM database utilizing the retail mobile purchase software application.

The retail mobile purchase software may include a checkout module. The checkout module may include a credit request module, a payment module, an update records module, and a receipt module. Each of these modules may also be referred to as software applications, plug-in software, etc.

In an embodiment of the invention, a salesperson may suspend a transaction. A transaction may be suspended because the purchaser has decided to continue shopping and looking for additional items, the purchaser had to leave the retail store but plans on coming back, a new salesperson is taking over the transaction or for a number of different reasons. If a transaction is to be suspended, the retail mobile purchase software application may receive a suspend notification. Illustratively, there may be a menu option where a salesperson selects a suspend icon or the portable electronic device may have a button that is depressed to indicate that a transaction should be suspended. Once the suspend notification is received, the retail mobile purchase software saves all of the purchaser and transaction information that has been entered. Illustratively, if two items have been scanned and item information has been received, the item information for the two scanned items is saved. If information regarding the purchaser has been received, the retail mobile purchase software saves the purchaser information. The saved information may be referred to as the suspended transaction information. In an embodiment of the invention, the suspended transaction information is stored in a memory at the portable electronic device by the retail mobile purchase software. In an embodiment of the invention, the suspended transaction information is transmitted, by the retail mobile purchase software application, to the retail purchase server for storage into a memory. When a salesperson wants to activate the suspended transaction, the salesperson may select an icon or depress a button. The retail mobile purchase software application may receive the activation instructions and may retrieve the suspended transaction information. The suspended transaction information is retrieved from the portable electronic device or the retail purchase server and the transaction is resumed at the point at which the transaction was suspended.

In an embodiment of the invention, if a purchaser is looking to obtain credit from the retailer, the retail mobile purchase software may activate or open 115 a credit request module. For example, the portable electronic device may display a menu including a request credit option (which may be selected via a button or menu selection). The credit request software application may receive customer identification information from the purchaser. Illustratively, the customer identification information may include a social security number, a government identification number, purchaser date of birth, purchaser address, etc. The customer identification information may also include the purchasers' next of kin, and drivers' license number. After the credit request module receives the customer identification information, the input customer identification information is transmitted 116 by the retail purchase mobile software to a credit facility. This transmission of the customer identification information is secure and encrypted. Under certain operating conditions, the customer identification information is transmitted to the retail purchase server wirelessly. The server then uses a secured wired connection to transmit the customer identification information between the retail purchase server and the credit facility 117. The credit facility determines 118 whether or not the customer receives approval and also provides a credit amount for the purchaser. The approval (and the credit amount) is transmitted to the retail purchase server and to the retail mobile purchase software application on the portable electronic device. In an embodiment of the invention, the retail mobile purchase software may interact directly with the credit facility.

The credit request module of the retail mobile purchase software application receives 119 the credit approval (and credit amount) or the credit denial 119. After the portable electronic device and the credit request module have received the credit approval or denial, the retail mobile purchase software application closes the credit request module. Illustratively, the credit request screen may be closed on the display of the portable electronic device and the retail purchase main menu may appear on the display of the portable electronic device. The credit request, approval, denial process takes only a few minutes and is performed utilizing the retail mobile purchase software application on the portable electronic device, without the purchaser (or credit applicant) having to fill in, sign and submit a form. This is a significant improvement on the current credit application process within a retail store. The credit facility may be an external credit facility (such as Experian, Transunion, Equifax) or could be an internal credit facility (such as GE Credit Corporation), or a retail store's own credit facility (such as a Macy's credit facility or a Bloomingdale's credit facility).

The retail mobile purchase application software may receive payment-processing input identifying that payment for the order is to begin or proceed. The retail mobile purchase software opens 120 a payment module (or payment software application). Illustratively, a user of the portable electronic device (e.g., a salesperson) may select a payment icon on the display and an order payment menu may be displayed. For example, the order payment menu may be a tender screen that includes an initial amount, additional fees charged, discounts received, a subtotal, taxes and a total amount.

An advantage and unique aspect of the payment module is that the payment module can accept multiple credit cards as payment for the order using the retail mobile purchase application software installed on the portable electronic device. A further advantage and unique aspect of the payment module is that the payment module can accept debit cards, credit cards, store gift cards and cash as payment for one order. In other words, it can accept any combination of the debit cards, gift cards, or credit cards as payment for a single transaction. Illustratively, the payment menu may include a cash payment icon, a gift card icon and a credit card icon.

The payment module with the retail mobile purchase software application may receive a cash payment selection indicating that the purchaser is paying cash for at least a part of the order 121. After receiving the cash payment selection, the payment module may receive cash payment information (e.g., an amount in dollars and cents). The payment module of the retail mobile purchase software application determines if the cash payment information is enough to satisfy the order payment amount. If the payment amount is determined to be enough, the payment is complete and retail mobile purchase software application closes the payment module. Illustratively, a cash payment screen may be displayed and the salesperson may input the cash amount into the payment module of the retail mobile purchase software application.

The payment module of the retail mobile purchase software may receive a credit card selection indicating that the purchaser may be using a credit card or debit card to pay for all of the order amount or at least part of the order amount 124. Illustratively, the credit card or debit card icon may be selected from the payment main menu. After receiving the credit/debit card selection, the salesperson may swipe the credit card through a payment-receiving device on the portable electronic device and the reader may transmit 124 the encrypted scanned credit card information via a secured connection to the payment module of the retail mobile purchase software application. In an embodiment of the invention, the payment module may receive the authorization code after it is manually entered into by the salesperson. The salesperson can also enter the payment amount and the payment module may receive this amount. Alternatively, a salesperson may manually enter the credit card number, the verification code and the payment amount and all of this information is transmitted to the payment module. In an embodiment of the invention, the payment module of the retail mobile purchase software application then transmits this information (number, code, and amount) to a third-party credit verifier and the third-party credit verifier transmits either a credit approval or a credit denial back to the payment module in the portable electronic device. In an alternative embodiment of the invention, the payment module of the retail mobile purchase software application may transmit the credit information to the retail purchase server and the retail purchase server may transmit the credit information to the third-party credit verifier. After the third party verifier transmits the authorization and the payment module of the retail mobile purchase software application receives the authorization (either directly or indirectly through the retail purchase server), the payment module subtracts the payment amount charged to the credit card from the order amount. If the credit card amount is enough to satisfy the order amount, the payment module is complete and the retail purchase application software closes the payment module.

A purchaser may also utilize either an additional credit card, (e.g. a second credit card, or a second credit card plus a third credit card) to make 125 payment amounts for the completed order. This allows the purchaser to spread the purchase among a number of different credit cards. The process described above for the first credit card is also utilized for the second, third or subsequent credit cards. This is a significant advantage over existing systems that allow only one credit card to be utilized for a transaction involving a portable electronic device in a retail environment. After the authorization is received from the last third party credit verifier, and payment for the completed order has been completed, the retail purchase application software closes the payment module. Illustratively, the payment menu may be closed on the portable electronic device and the retail purchase menu may appear on the screen of the display module.

Gift cards are processed in a similar fashion as credit cards are processed, the payment amount is transmitted to the bank or store issuing the gift card, and an authorization amount is received back. The retail mobile purchase software application will deduct the authorized amount from the total due. The payment module may receive a gift card selection indicating that the purchaser may be utilizing a gift card to pay for all of the order or at least part of the order. Illustratively, a gift card icon may be selected from the payment main menu. The gift card may be a store gift card or another general-purpose gift card. After receiving the gift card selection, the salesperson may swipe the gift card through the payment-receiving device on the portable electronic device. The payment-receiving device may be a magnetic reader or barcode scanner. The payment-receiving device may transmit 122/123 the gift card information and potentially an authorization code to the payment module. Alternatively, a salesperson may manually enter the gift card number and the authorization code and the payment module may receive the gift card number and potentially an authorization code. The payment module may transmit the gift card number and the authorization code to a third party verifier to verify that the gift card is authentic. For example, Authorize.net and/or PayPal may be a third party verifier of gift cards. The payment module may receive an authorization back from the third party verifier. After the third party verifier receives the authorization, the payment module subtracts the gift card amount from the order amount. If the gift card amount is enough to satisfy the order amount, the payment module is complete and the retail purchase application closes the payment module. In an embodiment of the invention, the payment module of the retail mobile purchase software application transmits the gift card number and the authorization code to the retail purchase server, which in turn transmits the information to the third party verifier.

A purchaser may also utilize all or a portion of any credit which was applied for 116 in the credit module and granted 119 as payment for the completed order.

After the total amount of purchase is tendered 128 and received by the payment module of the retail mobile purchase software application, the retail mobile purchase software application may generate and present a list of delivery options. The customer may choose a delivery option if appropriate and a shipping module of the retail mobile purchase software application may receive the selected delivery option 129. If the product needs to be shipped to the purchaser, the shipping module generates a shipping request that is sent to an inventory database. The shipping module of the retail mobile purchase software application transmits the shipping request to retail purchase server and specifically to the inventory database. The inventory database receives the shipping request and generates a shipping schedule 130 for the purchased products. A warehouse system receives the shipping schedule 131 and generates shipping and delivery instructions to meet the delivery guidelines.

The product is then shipped or delivered 132, and delivery information is transmitted back to the POS database in the retail purchase server. The purchased products are then shipped from the warehouse to the purchaser. The delivery provider generates 133 tracking data for the shipment of the purchased products and sends the tracking data via email to the purchaser's email address. The delivery provider provides the tracking data via email until the purchased product is delivered. In an embodiment of the invention, the tracking and delivery information is sent to the retail purchase server, which stores the customer email address, and the retail purchase server transmits the tracking and delivery information to the purchases at the stored email address.

The retail mobile purchase software may also include a receipt module or receipt software application. Illustratively, a salesperson may select a checkout/receipt icon on the display of the portable electronic device and the retail mobile purchase software application may initiate a receipt module. The receipt module may receive 134 receipt information. The receipt information may indicate that the purchaser requests 135 a printed receipt. If the receipt request corresponds to a printed receipt, the receipt module of the retail mobile purchase software application generates printing instructions including the transaction amount and item description information, and transmits the printing instructions to a printer module of the retail mobile purchase software application, which prints 135 the receipt on the portable electronic device (if the portable electronic device includes a printer). In embodiments of the invention, the printer module of retail mobile purchase software application may also print the receipt to printers located within the retail location. The print module includes functionality to add printers from the retail location to interface with the retail mobile purchase software application.

The salesperson may separately, or also, select an email icon from a receipt menu 136. If the received receipt information indicates that the purchaser requests an emailed receipt, the receipt module of the retail mobile purchase software application requests a purchaser's email address 136. The receipt module receives the purchaser's email address and the receipt module of the retail mobile purchase software application generates email instructions including the transaction and the item description information and transmits this information to an email server. The salesperson may separately, or also, select a text or a text icon from a receipt menu 137. If the receipt information indicates that the purchaser requests a text message receipt, the receipt module of the retail mobile purchase software application requests a purchaser's phone number 137. The receipt module receives the purchaser's phone number and generates a text message including the payment amount, the item description and additional information. The receipt module of the retail mobile purchase software application transmits this text message via a cellular phone message to the purchaser's phone.

In an embodiment of the invention, the checkout/receipt module of the retail mobile purchase software application may also receive a photo image of the purchaser and/or a digitally captured signature 138 from the purchaser. Illustratively, the salesperson may utilize a camera in the portable electronic device to take a picture of the purchaser. The camera application generates the photo image and stores the photo image in a memory of the portable electronic device. In an embodiment of the invention, the memory may be a temporary memory of the portable electronic device and not a permanent memory of the portable electronic device. If a photo receipt option is selected, via a photo image icon for example, the checkout/receipt module of the retail mobile purchase software retrieves a copy of the photo image and sends the photo image along with the transaction amount and item description information to the printer module, the email server or to the purchaser's cellular phone.

After a receipt format has been selected, the retail mobile purchase software application closes the receipt module 139. The retail mobile purchase software application is closed 139.

Some or all these aspects of the invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

1. A portable electronic device, the portable electronic device including:
a memory;
a display; and
a processor,
the memory storing instructions which when executed by the processor, cause the portable electronic device to:
transmit an item search request to a server;
receive item information including item description and item price corresponding to the item search request from the server;
receive a purchase selection corresponding to the received item information;
create an order including a selected item corresponding to the received item information;
display payment options for the order on the display;
receive a payment option selection for the order;
receive payment confirmation for the order;
display receipt options for the order on the display; and
generate an electronic receipt for the order.

2. The portable electronic device of claim 1, wherein the memory includes instructions, which when executed by the processor cause the portable electronic device to:
transmit the electronic receipt via email to a purchaser portable electronic device.

3. The portable electronic device of claim 1, the memory including instructions, which when executed by the processor cause the portable electronic device to:
transmit the electronic receipt via text to a purchaser electronic device.

4. The portable electronic device of claim 1, the memory including instructions, which when executed by the processor cause the portable electronic device to:
receive an image associated with the order;
link the received image with the generated electronic receipt; and
generate an updated receipt including an image for the order.

5. The portable electronic device of claim 4, wherein the memory includes instructions, which when executed by the processor cause the portable electronic device to:
transmit the electronic receipt via email to a purchaser portable electronic device.

6. The portable electronic device of claim 4, the memory including instructions, which when executed by the processor cause the portable electronic device to:
transmit the electronic receipt via text to a purchaser electronic device.

7. The portable electronic device of claim 1, the memory further including instructions which when executed cause the portable electronic device to:
receive a selection of credit card payment as the payment option selection;
receive first credit card information and transmit the first credit card information to a merchant to pay a first amount which is not a full amount of the order;
receive authorization for the first amount for the first credit card;
receive second credit card information and transmit the second credit card information to the merchant to pay a second amount which is not a full amount of the order, and
receive authorization for the second amount for the second credit card.

8. The portable electronic device of claim 1, the memory including instructions, which when executed by the processor cause the portable electronic device to:
receive a selection of credit card payment as a payment option selection;
receive first credit card information and transmit the first credit card information to a merchant to pay a first amount which is not a full amount of the order;
receive authorization for the first amount for the first credit card;
receive a selection of a gift card as a payment option selection to pay a second amount which is not a full amount of the order;
receive gift card information and transmit the gift card information to a verifier to verify authenticity of the gift card; and
receive authorization from the verifier that the gift card is authentic.

9. The portable electronic device of claim 1, the memory including instructions which when executed by the processor cause the portable electronic device to:
receive a selection of credit card payment as the payment option selection;
receive credit card information and transmit the credit card information to a merchant to pay a first amount which is not a full amount of the order;
receive authorization for the first amount for the credit card;
receive a selection of debit card payment as the payment option selection;
receive debit card information and transmit the debit card information to the merchant to pay a second amount which is not a full amount of the order, and
receive authorization for the second amount for the debit card.

10. The portable electronic device of claim 1, the memory including instructions, which when executed by the processor cause the portable electronic device to:
receive a suspension request; and
storing all information regarding the order into a memory on the portable electronic device.

11. The portable electronic device of claim 1, the memory including instructions, which when executed by the processor cause the portable electronic device to:
transmit a credit request to a credit facility server; and
receive an approval or denial for the credit request from the credit facility server.
